(19) United States
(12) Patent Application Publication
(10) Pub. No.: US 2018/0312005 A1
(43) Pub. Date: Nov. 1, 2018

(54) Pneumatic Tire, Having Working Layers Comprising Monofilaments And A Tire Tread With Grooves

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Aymeric BONNET, Clermont-Ferrand Cedex 9 (FR); Jacques MOREL-JEAN, Clermont-Ferrand Cedex 9 (FR); Jean-Charles DEROBERT-MAZURE, Clermont-Ferrand Cedex 9 (FR)

(21) Appl. No.: 15/771,617

(22) PCT Filed: Oct. 26, 2016
(86) PCT No.: PCT/EP2016/075729

§ 371 Date: Apr. 27, 2018

(30) Foreign Application Priority Data
Oct. 27, 2015 (FR) 1560237

(51) Int. Cl. B60C 9/00; B60C 9/22

(52) U.S. Cl. CPC B60C 9/0064; B60C 2009/2019; B60C 9/22

(57) ABSTRACT

Technique to increase the endurance of tires comprising two working layers (41, 42), comprising mutually parallel reinforcing elements (411, 421) each forming, with the circumferential direction (XX′) of the tire, an oriented angle (A1, A2) the absolute value of which is at least equal to 20° and at most equal to 50°, such that these respective angles are of opposite sign. The reinforcing elements of each ply are made up of individual metal threads or monofilaments having a cross section the smallest dimension of which is at least equal to 0.20 mm and at most equal to 0.5 mm. The tire also comprises axially exterior major grooves (24) in the tread (2). The mean linear profile L of the axially exterior major grooves (24) of a width W at least equal to 1 mm and of a depth D at least equal to 5 mm forms, with the circumferential direction (XX′), an angle C belonging to the interval [min(A1,A2)+100°, max(A1, A2)+80°].

### FIELD OF THE INVENTION

The present invention relates to a passenger vehicle tire, and more particularly to the crown of such a tire.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

A tire comprises a crown comprising a tread that is intended to come into contact with the ground via a tread surface, two beads that are intended to come into contact with a rim, and two sidewalls that connect the crown to the beads. Furthermore, a tire comprises a carcass reinforcement, comprising at least one carcass layer, radially on the inside of the crown and connecting the two beads.

The tread of a tire is delimited, in the radial direction, by two circumferential surfaces of which the radially outermost is referred to as the tread surface and of which the radially innermost is referred to as the tread pattern bottom surface. In addition, the tread of a tire is delimited, in the axial direction, by two lateral surfaces. The tread is also made up of one or more rubber compounds. The expression “rubber compound” refers to a composition of rubber comprising at least one elastomer and a filler.

The crown comprises at least one crown reinforcement radially on the inside of the tread. The crown reinforcement comprises at least one working reinforcement comprising at least one working layer made up of mutually parallel reinforcing elements that form, with the circumferential direction, an angle of between 15° and 50°. The crown reinforcement may also comprise a hoop reinforcement comprising at least one hooping layer made up of reinforcing elements that form, with the circumferential direction, an angle of between 0° and 10°, the hoop reinforcement usually, although not necessarily, being radially on the outside of the working layers.

In order to obtain good grip on wet ground, cuts are made in the tread. A cut denotes either a well, or a groove, or a sipe, or a circumferential groove and forms a space opening onto the tread surface. On the tread surface, a well has no characteristic main dimension. A sipe or a groove has, on the tread surface, two characteristic main dimensions: a width W and a length Lo, such that the length Lo is at least equal to twice the width W. A sipe or a groove is therefore delimited by at least two main lateral faces determining its length Lo and connected by a bottom face, the two main lateral faces being distant from one another by a non-zero distance referred to as the width W of the sipe or of the groove.

By definition, a sipe or a groove which is delimited by:
only two main lateral faces is said to be open-ended,
by three lateral faces, two of them being main faces determining the length of the cut, is said to be blind,
by four lateral faces, two of them being main faces determining the length of the cut, is said to be double-blind.

The difference between a sipe and a groove is the value of the mean distance separating the two main lateral faces of the cut, namely its width W. In the case of a sipe, this distance is suitable for allowing the mutually-facing main lateral faces to come into contact when the sipe enters the contact patch in which the tire is in contact with the road surface. In the case of a groove, the main lateral faces of this groove cannot come into contact with one another under usual running conditions. This distance for a sipe is generally, for passenger vehicle tires, at most equal to 1 millimetre (mm). A circumferential groove is a cut of substantially circumferential direction that is substantially continuous over the entire circumference of the tire.

More specifically, the width W is the mean distance, determined along the length of the cut and along a radial portion of the cut, comprised between a first circumferential surface, radially on the inside of the tread surface at a radial distance of 1 mm, and a second circumferential surface, radially on the outside of the bottom surface at a radial distance of 1 mm, so as to avoid any measurement problem associated with the junctions at which the two main lateral faces meet the tread surface and the bottom surface.

The depth of the cut is the maximum radial distance between the tread surface and the bottom of the cut. The maximum value of the depths of the cuts is referred to as the tread depth D. The tread pattern bottom surface, or bottom surface, is defined as being the surface of the tread surface translated radially inwards by a radial distance equal to the tread depth.

### PRIOR ART

In the current context of sustainable development, the saving of resources and therefore of raw materials is one of the industry's key objectives. For passenger vehicle tires, one of the avenues of research for achieving this objective is to replace the metal cords usually employed as reinforcing elements in various layers of the crown reinforcement with individual threads or monofilaments as described in document EP 0043563 in which this type of reinforcing element is used with the twofold objective of saving weight and lowering rolling resistance.

However, the use of this type of reinforcing element has the disadvantage of causing these monofilaments to buckle under compression, causing the tire to exhibit insufficient endurance, as described in document EP2537686. As that same document describes, a person skilled in the art proposes a particular layout of the various layers of the crown reinforcement and a specific quality of the materials that make up the reinforcing elements of the crown reinforcement in order to solve this problem.

An analysis of the physical phenomenon shows that the buckling of the monofilaments occurs in the axially outermost parts of the tread underneath the grooves, as mentioned in document JP 2012071791. This region of the tire has the particular feature of being subjected to high compression loadings when the vehicle is running in a curved line. The resistance of the monofilaments to buckling is dependent on the geometry of the grooves, thus demonstrating the surprising influence that the tread pattern has on the endurance of the monofilaments.

### SUMMARY OF THE INVENTION

The key objective of the present invention is therefore to increase the endurance of a tire the working layer reinforcing elements of which are made up of monofilaments, through the design of a suitable tread pattern for the tread.

This objective is achieved by a passenger vehicle tire comprising:
a tread intended to come into contact with the ground via a tread surface and having an axial width LT,
the tread comprising two axially exterior portions each having an axial width (LS1, LS2) at most equal to 0.3 times the axial width LT,
at least one axially exterior portion comprising axially exterior grooves, an axially exterior groove forming a space opening onto the tread surface and being delimited by at least two main lateral faces connected by a bottom face,
at least one axially exterior groove, referred to as major groove, having a width W, defined by the distance between the two lateral faces, at least equal to 1 mm, a depth D, defined by the maximum radial distance between the tread surface and the bottom face, at least equal to 5 mm, and a mean linear profile L,
the tire further comprising a crown reinforcement radially on the inside of the tread,
the crown reinforcement comprising a working reinforcement and a hoop reinforcement,
the working reinforcement comprising at least two working layers each comprising reinforcing elements which are coated in an elastomeric material, mutually parallel and respectively form, with a circumferential direction (XX′) of the tire, an oriented angle (A1, A2) at least equal to 20° and at most equal to 50°, in terms of absolute value, and of opposite sign from one layer to the next,
the said reinforcing elements in each working layer being made up of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction (XX′) of the tire, an angle B at most equal to 10°, in terms of absolute value,
the mean linear profile L of any axially exterior major groove of at least one axially exterior portion of the tread forming, with the circumferential direction (XX′) of the tire, an angle C belonging to the interval [min(A1,A2)+100°, max(A1, A2)+80°],
the breaking strength R_{C} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

The intersection of the tread surface with the main lateral faces of a groove determines the main profiles of the groove. The mean linear profile of a groove is calculated by linear interpolation of these main profiles. The linear interpolation is done in the axial direction on the axially outermost part of the tread considered, it being possible for the groove to be of any shape, curved, sinusoidal, zigzag. The main profiles of the grooves are usually intuitively identifiable because the intersection between the tread surface and the lateral faces of the grooves is a curve. In the case of tires in which the tread surface and the lateral faces of the grooves meet continuously, the profiles of the grooves are determined by the intersection between the main lateral faces of the grooves and the tread surface translated radially by −0.5 mm.

Usually, the main profiles of the groove are substantially of the same shape and distant from one another by the width W of the groove.

For grooves of complex shape, what is meant by the width of the groove is the mean distance between the main lateral faces, averaged over the mean curved length of the main profiles of the groove.

From a mechanical operation standpoint, the buckling of a reinforcing element occurs in compression. It occurs only radially on the inside of the axially outermost portions of the tread because it is in this zone that the compressive loadings are highest in the event of transverse loading. These axially outermost portions each have as their maximum axial width 0.3 times the total width of the tread of the tire.

Buckling is a complex and unstable phenomenon which leads to fatigue rupture of an object that has at least one dimension one order of magnitude smaller than a main dimension, such as beams or shells. Monofilaments are objects of this type with a cross section very much smaller than their length. The phenomenon begins when the main dimension is placed under compression. It continues because of the asymmetry of geometry of the monofilament, or because of the existence of a transverse force caused by the bending of the monofilament, which is a stress loading that is highly destructive for metallic materials. This complex phenomenon is notably highly dependent on the boundary conditions, on the mobility of the element, on the direction of the applied load and on the deformation resulting from this load. If this deformation does not take place substantially in the direction of the main dimension of the monofilament, then buckling will not occur and, in the case of monofilaments surrounded by a matrix of rubber compound of the working layers of a tire, the load is absorbed by the shearing of the rubber compound between the monofilaments.

In addition, the buckling of the monofilaments of the working layers occurs only under the axially exterior grooves of the tread because, in the absence of an axially exterior groove, the rubber material of the tread radially on the outside of the reinforcing element absorbs most of the compressive load. Likewise, the axially exterior grooves the depth of which is less than 5 mm have no influence on the buckling of the monofilaments. Therefore, only the axially exterior grooves referred to as major grooves need to be subjected to special design rules when using monofilaments in the working layers. These axially exterior major grooves are particularly essential to the wet grip performance of the tire.

Moreover, the axially exterior grooves the width of which is less than 1 mm, also referred to as sipes, close when they enter the contact patch and therefore protect the monofilaments from buckling. In the case of the grooves that are not axially exterior, the compressive loading in the case of transverse loading of the tire is too low to cause buckling. Moreover, it is common practice in passenger vehicle tires for only sipes of a width less than 1 mm to be arranged in the axially central parts of the tread.

In directions in which no empty space allows for movement, the compressive loadings will be absorbed by the rubber compound. When an axially exterior major groove is present, this groove does not absorb the load, but rather allows movements in compression in the direction perpendicular to its mean linear profile. In order to avoid buckling, it is necessary for the compressive load not to be applied to the reinforcing element in the direction of its main dimension but to the rubbery material in compression and in shear. For that, it is necessary for the mean linear profile of the axially exterior major grooves present on the axially outermost portions, each having a maximum axial width equal to 0.3 times the axial width of the tread width, not to be perpendicular to any of the monofilaments radially on the inside of it, to an angular precision of 10°. With a deviation of more than 10°, the working layer considered absorbs compressive loadings through the shearing of the rubbery material with which the monofilaments are coated.

Specifically, calculations and testing show that a difference of 10° between the angle C of the mean linear profile of an axially exterior major groove and the perpendicular to the monofilament is enough to protect the latter from buckling over the portion of tread considered. If a working reinforcement is made up of two working layers comprising monofilaments that are crossed from one working layer to the next, forming angles A1 and A2 with the circumferential direction of the tire, then the mean angle C of the axially exterior major groove can belong neither to the angles interval [A1+80°; A1+100°] nor to the angles interval [A2+80°; A2+100°]. Because of the target grip performance, the mean linear profile cannot be substantially circumferential: it must therefore belong to the angles interval [min(A1,A2)+100°; max(A1, A2)+80°]. This interval is expressed for plus or minus 180° or, in other words, modulo pi. The axially exterior major grooves may be open-ended, blind or double-blind. The angles of the reinforcing elements of the working layers are measured at the equatorial plane.

The angle C made by the mean linear profile L of the axially exterior major groove with the circumferential direction is the oriented angle comprised between the circumferential direction XX′ and the vector having, as origin, the axially innermost point of the mean linear profile and, as end, the axially outermost point of the mean linear profile.

The two axially exterior portions of the tread may potentially contain one or more circumferential grooves in order to reduce the risk of aquaplaning on wet ground. For passenger vehicle tires, these circumferential grooves generally represent a small width of the contact patch and have no known impact on the buckling of the monofilaments.

The major grooves may also contain protuberances or bridges, these bridges being potentially able to contain a sipe with a mean width of less than 1 mm.

The monofilaments may have any cross-sectional shape, in the knowledge that oblong cross sections represent an advantage over circular cross sections, even when of smaller size, because their second moment of area in bending and, therefore, their resistance to buckling, are higher. In the case of a circular cross section, the smallest dimension corresponds to the diameter of the cross section. In order to guarantee the fatigue breaking strength of the monofilaments and the resistance to shearing of the rubber compounds situated between the filaments, the density of reinforcing elements of each working layer is at least equal to 100 threads per dm and at most equal to 200 threads per dm. What is meant by the density is the mean number of monofilaments over a 10-cm width of the working layer, this width being measured perpendicularly to the direction of the monofilaments in the working layer considered. The distance between consecutive reinforcing elements may be fixed or variable. The reinforcing elements may be laid during manufacture either in layers, in strips, or individually.

Furthermore, the resistance of a monofilament to buckling is also dependent on the resistance of the axially adjacent filaments, the onset of buckling in one being able to lead to the buckling of another through the effect of a distribution of load around the monofilament that is buckling. In order to obtain improved endurance performance, it is appropriate not only to observe monofilament density and diameter conditions but also to satisfy a condition relating to the strength of the working layer, namely the breaking strength R_{C} of each working layer which needs to be at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

For a tire for which no specific direction of mounting is imposed, the solution involves applying the invention to the two axially outermost portions of the tread.

For a tire for which a specific direction of mounting is imposed, one option is to apply the invention to only that axially outermost portion of the tread that is situated on the outboard side of the vehicle.

The tread patterns of passenger vehicle tires are usually either substantially symmetric or substantially antisymmetric, or substantially asymmetric.

It is particularly advantageous for the angle C of the mean linear profile L of any axially exterior major groove of at least one axially exterior portion of the tread to belong to the interval [min(A1,A2)+105°, max(A1, A2)+75°]. This interval is expressed for plus or minus 180° or, in other words, modulo pi. This increase in the restriction on the angle of the mean profile L makes it possible to ensure a resistance to buckling of the monofilaments of the working layers that is higher according to the usage requirement.

One preferred solution is for the angle C of the mean linear profile L of any axially exterior major groove of at least one axially exterior portion of the tread to belong to the interval [(A1+A2)/2+80°, (A1+A2)/2+100°]. This interval is expressed for plus or minus 180° or, in other words, modulo pi. This is because, in this specific instance, given that the absolute values of the angles A1 and A2 are at least equal to 20°, the angle between their bisector and the directions of the monofilaments of the two working layers is therefore at least equal to 20° as so too is the difference between their respective perpendiculars. By positioning the axially exterior major grooves in such a way that their mean linear profile is close to the bisector of the angle formed by the two perpendiculars to the monofilaments of the two working layers, the compressive stress loadings on the two layers of monofilaments are equalized in such a way as to make best use of the strengths of the two working layers.

It is advantageous for any axially exterior major groove to have a width W at most equal to 10 mm so as to limit the void volume of the tread and preserve the wearability of the tire.

For preference, any axially exterior major groove has a depth D less than 8 mm. This is because beyond a certain thickness, the tread becomes too flexible and the tire does not perform so well in terms of wear, behaviour and rolling resistance.

For preference, the axially exterior major grooves are spaced apart, in the circumferential direction (XX′) of the tire, by a circumferential spacing P at least equal to 8 mm, in order to avoid excessive flexibility of the tread and loss of wearing and rolling-resistance performance. The circumferential spacing is the mean circumferential distance, over the relevant axially outermost portion of the tread, between the mean linear profiles of two circumferentially consecutive axially exterior major grooves. Usually, the treads of tires may have circumferential spacings that are variable notably so as to limit road noise.

One preferred solution is for the axially exterior major grooves to be spaced apart, in the circumferential direction (XX′) of the tire, by a circumferential spacing P at most equal to 50 mm, in order to guarantee good grip on wet ground.

It is particularly advantageous for the bottom face of an axially exterior major groove to be positioned radially on the outside of the crown reinforcement at a radial distance D1 at least equal to 1.5 mm. This is because this minimal quantity of rubbery material protects the crown from attack and puncturing by obstacles, stones, or any debris lying on the ground.

It is preferable for the radial distance between the bottom face of the axially exterior major grooves and the radially outermost reinforcing elements of the crown reinforcement to be at most equal to 3.5 mm in order to obtain a tire that performs well in terms of rolling resistance.

For preference, at least an axially exterior portion, comprising axially exterior major grooves, comprises sipes having a width W1 at most equal to 1 mm. In order to improve grip on certain types of ground, notably on ground covered with black ice or snow, it is possible to provide small-width sipes in the axially exterior portions of the tread, without impairing the endurance of the tire the working reinforcement of which contains monofilaments. This is because when these sipes enter the contact patch, their main profiles come into contact with one another and the rubbery material of the tread then absorbs the compressive loadings. These sipes may have widths that are variable in the direction of the main profiles or in their depth as long as their minimum width is at most equal to 1 mm over a sufficient surface area, for example at least equal to 50 mm².

It is also possible to provide grooves of small depth, smaller than 5 mm, without significantly impairing the endurance of the tire, although, in this case, the performance, notably the wet grip performance, becomes degraded as the tire wears.

Advantageously, the two axially exterior portions of the tread each have an axial width (LS1, LS2) at most equal to 0.2 times the axial width LT of the tread.

It is advantageous for the two working layers to be crossed and for the angles of the respective reinforcing elements of the working layers to be equal in terms of absolute value. This embodiment offers advantages in terms of manufacture, product standardization, and therefore production costs. This equality of the angles is satisfied to within the manufacturing tolerances, namely to within plus or minus 2°.

One preferred solution is for each working layer to comprise reinforcing elements which form, with the circumferential direction (XX′) of the tire, an angle at least equal to 22° and at most equal to 35°, which constitute an optimal compromise between tire behaviour and tire endurance performance.

For preference, each working layer comprises reinforcing elements made up of individual metal threads or monofilaments having a cross section the smallest dimension of which is at least equal to 0.3 mm and at most equal to 0.37 mm, which constitute an optimum for balancing the target performance aspects: weight saving and buckling endurance of the reinforcing elements of the working layers.

The reinforcing elements of the working layers may or may not be rectilinear. They may be preformed, of sinusoidal, zigzag, or wavy shape, or following a spiral. The reinforcing elements of the working layers are made of steel, preferably carbon steel such as those used in cords of the “steel cords” type, although it is of course possible to use other steels, for example stainless steels, or other alloys.

When a carbon steel is used, its carbon content (% by weight of steel) is preferably comprised in a range from 0.8% to 1.2%. The invention is particularly applicable to steels of the very high strength “SHT” (“Super High Tensile”), ultra-high strength “UHT” (“Ultra High Tensile”) or “MT” (“Mega Tensile”) steel cord type. The carbon steel reinforcers then have a tensile breaking strength (Rm) preferably higher than 3000 MPa, more preferably higher than 3500 MPa. Their total elongation at break (At), which is the sum of the elastic elongation and the plastic elongation, is preferably greater than 2.0%.

As far as the steel reinforcers are concerned, the measurements of breaking strength, denoted Rm (in MPa), and elongation at break, denoted At (total elongation in %), are taken under tension in accordance with ISO standard 6892 of 1984.

The steel used, whether it is in particular a carbon steel or a stainless steel, may itself be coated with a layer of metal which improves for example the workability of the steel monofilament or the wear properties of the reinforcer and/or of the tire themselves, such as properties of adhesion, corrosion resistance or even resistance to ageing. According to one preferred embodiment, the steel used is covered with a layer of brass (Zn—Cu alloy) or of zinc; it will be recalled that, during the process of manufacturing the wire threads, the brass or zinc coating makes the wire easier to draw, and makes the wire thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

It is advantageous for the density of reinforcing elements in each working layer to be at least equal to 120 threads per dm and at most equal to 180 threads per dm in order to guarantee improved endurance of the rubber compounds working in shear between the reinforcing elements and the tension and compression endurance thereof.

For preference, the reinforcing elements of the at least one hooping layer are made of textile, preferably of aliphatic polyamide, aromatic polyamide or combination of aliphatic polyamide and of aromatic polyamide, polyethylene terephthalate or rayon type, because textile materials are particularly well-suited to this type of use because of their low mass and high rigidity. The distance between consecutive reinforcing elements in the hooping layer, or spacing, may be fixed or variable. The reinforcing elements may be laid during manufacture either in layers, in strips, or individually.

It is advantageous for the hoop reinforcement to be radially on the outside of the working reinforcement in order to ensure good endurance of the latter.

### BRIEF DESCRIPTION OF THE DRAWINGS

The features and other advantages of the invention will be understood better with the aid of FIGS. 1 to 8, the said figures being drawn not to scale but in a simplified manner so as to make it easier to understand the invention:

FIG. 1 is a perspective view depicting part of the tire according to the invention, particularly its architecture and its tread.

FIG. 2 depicts a meridian section through the crown of a tire according to the invention and illustrates the axially exterior parts 22 and 23 of the tread, and the width thereof.

FIGS. 3A and 3B depict two types of radially exterior meridian profile of the tread of a passenger vehicle tire.

FIG. 4 illustrates various possible types of axially exterior groove 24.

FIG. 5 illustrates the angle characteristic for the angle C of the mean linear profile L of any axially exterior major groove belonging to the interval [min(A1,A2)+100°, max(A1, A2)+80°].

FIG. 6 illustrates the angle characteristic for the angle C of the mean linear profile L of any axially exterior major groove belonging to the interval [(A1+A2)/2+80°, (A1+A2)/2+100°].

FIGS. 7A, 7B, 7C illustrate a method for determining the major grooves in the case of a network of grooves.

FIG. 8 illustrates the terms “interior edge” and “exterior edge” of a tread.

### DETAILED DESCRIPTION OF THE DRAWINGS

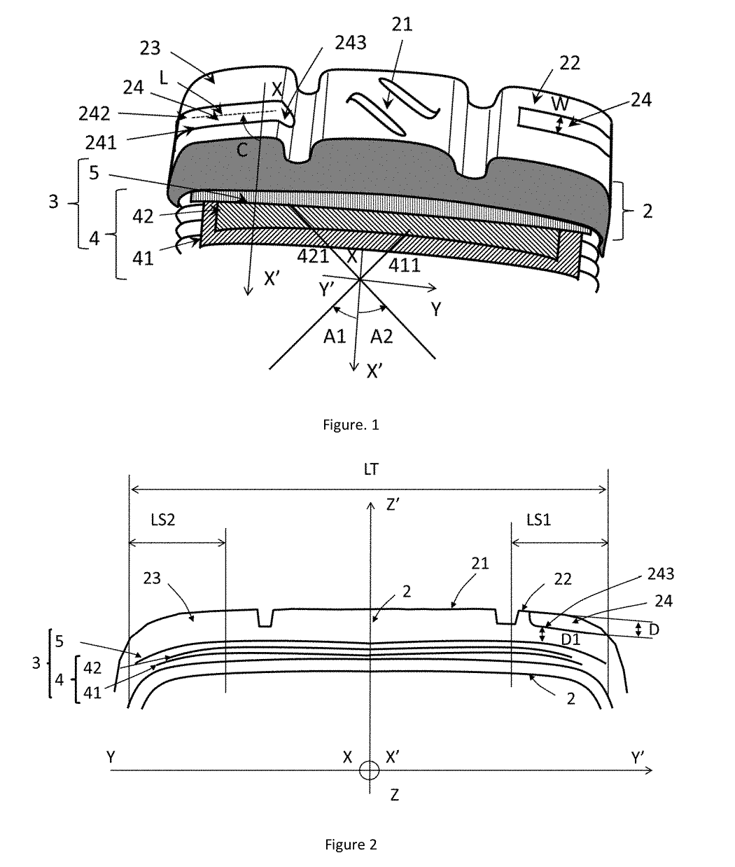

FIG. 1 is a perspective view of a part of the crown of a tire. The tire comprises a tread 2 which is intended to come into contact with the ground via a tread surface 21. In the axially exterior portions 22 and 23 of the tread there are axially exterior grooves 24 of width W and of mean linear profile L forming an angle C with the circumferential direction XX′ of the tire. The tire further comprises a crown reinforcement 3 comprising a working reinforcement 4 and a hoop reinforcement 5. The working reinforcement comprises two working layers 41 and 42 each comprising reinforcing elements (411, 421) which are mutually parallel and respectively form, with a circumferential direction (XX′) of the tire, an oriented angle (A1, A2) at least equal to 20° and at most equal to 50°, in terms of absolute value, and of opposite sign from one layer to the next.

FIG. 2 is a schematic meridian section through the crown of the tire according to the invention. It illustrates in particular the widths LS1 and LS2 of the axially exterior portions 22 and 23 of the tread, and the total width of the tread of the tire LT. The depth D of an axially exterior groove 24, and the distance D1 between the bottom face 243 of an axially exterior groove 24 and the crown reinforcement 3, measured along a meridian section of the tire, are also depicted. A meridian section of the tire is obtained by cutting the tire on two meridian planes. By way of example, a meridian section of tire has a thickness in the circumferential direction of around 60 mm at the tread. The measurement is taken with the distance between the two beads being kept identical to that of the tire mounted on its rim and lightly inflated.

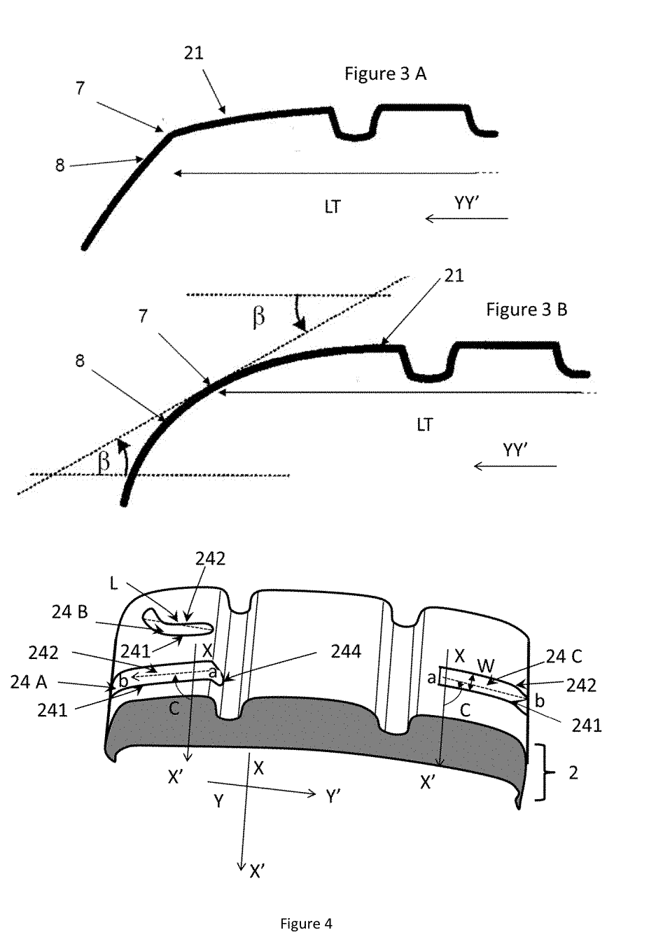

In FIGS. 3A and 3B, the axial edges 7 of the tread, that make it possible to measure the tread width, are determined. In FIG. 3A, in which the tread surface 21 is secant with the exterior axial surface of the tire 8, the axial edge 7 is determined by a person skilled in the art in a trivial way. In FIG. 3B, in which the tread surface 21 is continuous with the exterior axial surface of the tire 8, the tangent to the tread surface at any point on the said tread surface in the region of transition towards the sidewall is plotted on a meridian section of the tire. The first axial edge 7 is the point for which the angle β (beta) between the said tangent and an axial direction YY′ is equal to 30°. When there are several points for which the angle β between the said tangent and an axial direction YY′ is equal to 30°, it is the radially outermost point that is adopted. The same approach is used to determine the second axial edge of the tread.

FIG. 4 schematically depicts axially exterior grooves 24 in a tread 2. A person skilled in the art determines the main profiles 241 and 242 of the grooves, which are distant from one another by a distance W. These profiles are linearized into a mean linear profile L by linear interpolation of the profiles in the axial direction YY′. The axially innermost point a and the axially outermost point b of the mean linear profile L respectively define the origin and the end of the vector used to define the oriented angle C of the mean linear profile of a groove formed with the circumferential direction XX′. The grooves may be open-ended like the groove 24A, blind like the groove 24C or double-blind like the groove 24B.

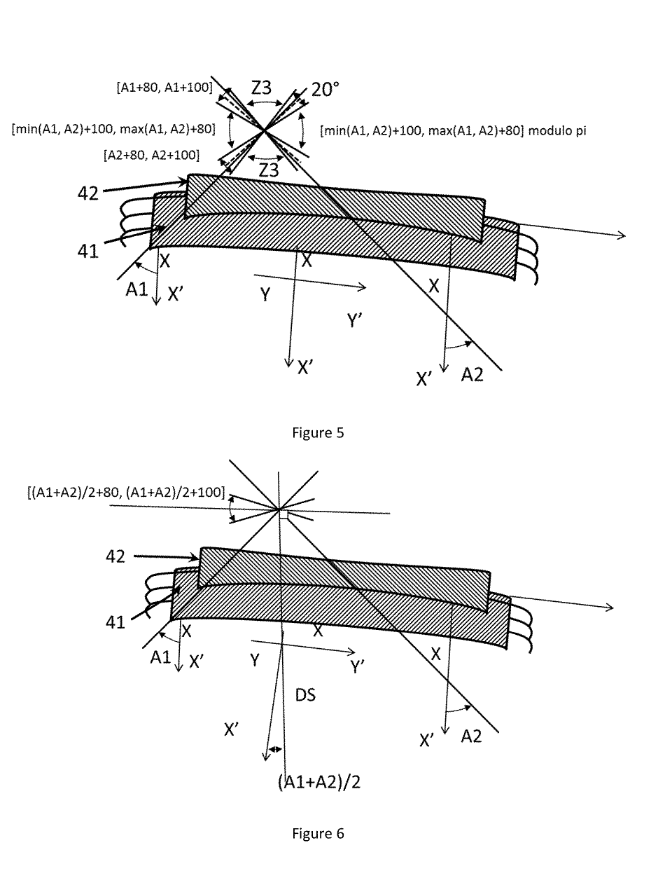

FIG. 5 depicts the angle characteristic for the angle C of the mean linear profile L of any axially exterior major groove belonging to the interval [min(A1,A2)+100°, max(A1, A2)+80°]. In order to avoid any buckling, the mean linear profile L must not be perpendicular to the monofilaments of the two working layers, to within plus or minus 10°. Hence, the angle C of the mean linear profile L belongs neither to the interval [A1+90°−10°, A1+90°+10°], namely [A1+80°, A1+100°], nor to the interval [A2+80°, A2+100°]. For reasons associated with wet grip, the angle C of the mean linear profile cannot belong to the zones Z3 close to the circumferential direction XX′. Hence, the angle C belongs to the interval [A2+100°, A1+80°] when A2 is negative, or conversely to the interval [A1+100°, A2+80°] when A1 is negative: this is expressed mathematically by writing that the angle C belongs to the interval [min(A1, A2)+100°, max(A1, A2)+80°], to within plus or minus 180°.

FIG. 6 depicts the angle characteristic for the angle C of the mean linear profile L of any axially exterior major groove belonging to the interval [(A1+A2)/2+80°, (A1+A2)/2+100°]. This feature means that the mean linear profile L of any axially exterior major groove is substantially perpendicular, to within + or −10° at most, to the bisector of the angle (A1+A2)/2, formed by the respective directions of the monofilaments of the two working layers.

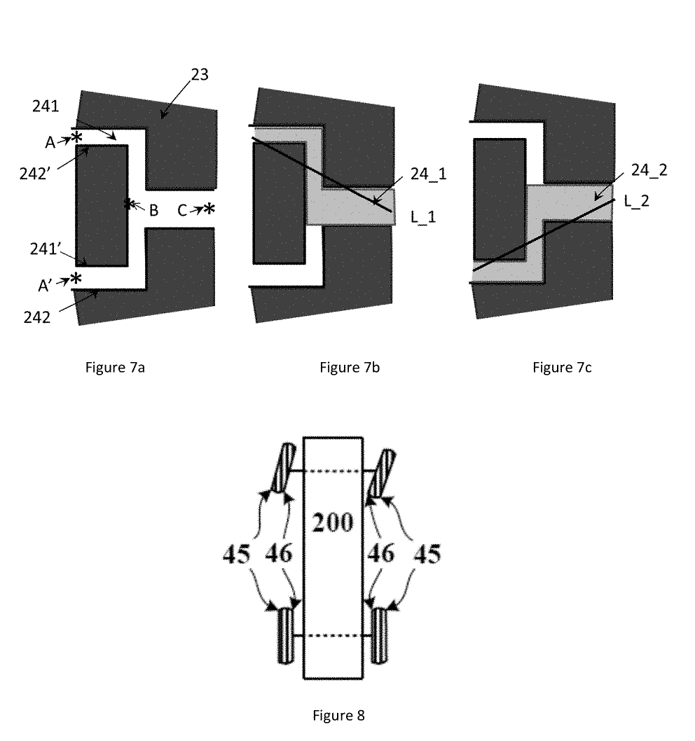

FIGS. 7A, 7B, 7C illustrate a method for determining the major grooves in the case of a network of grooves. For certain tread patterns, grooves open into other grooves as illustrated in FIG. 7A. In that case, the lateral faces of the network which are the continuous lateral faces most circumferentially distant from one another in the network of grooves will be determined, which in the present case are the lateral faces 241 and 242. The invention will be applied to all the grooves which, as their lateral faces, have one of the lateral faces of the network and the directly adjacent opposite lateral face. Let us therefore consider here the groove 24_1 (FIG. 7B), of mean linear profile L_1, made up of the lateral face of the network 241 and the opposite lateral face directly adjacent to (241, 242′), over a first portion leading from point A to point B, and of the lateral face of the network 241 and the opposite lateral face 242 directly adjacent to 241, over a second portion leading from point B to point C. Next, consider the groove 24_2 (FIG. 7C), of mean linear profile L_2, made up of the lateral face of the network 242 and the opposite lateral face 241′ directly adjacent to 242, over a first portion leading from point A to point B, and of the lateral face of the network 242 and the opposite lateral face 241 directly adjacent to 242, over a second portion leading from point B to point C. For more complex networks, this rule will be generalized so that all of the possible major grooves of the network substantially following the orientation of the lateral faces of the network satisfy the characteristics of the invention.

FIG. 8 schematically depicts tires mounted on mounting rims of wheels of a vehicle 200 and having a predetermined direction of mounting on the vehicle. Each tire comprises an exterior axial edge 45 and an interior axial edge 46, the interior axial edge 46 being the edge mounted on the bodyshell side of the vehicle when the tire is mounted on the vehicle in the said predetermined direction of mounting, and the exterior axial edge 45 being the opposite of that. In the document, the “outboard side of the vehicle” denotes the exterior axial edge 45.

The inventors have performed calculations on the basis of the invention for a tire of size 205/55 R16, inflated to a pressure of 2 bar, comprising two working layers comprising steel monofilaments of diameter 0.3 mm, distributed at a density of 158 threads to the dm and forming, with the circumferential direction, the angles A1 and A2 respectively equal to +27° and −27°. The monofilaments have a breaking strength Rₘ equal to 3500 MPa and the working layers each have a breaking strength R_{c} equal to 39 000 N/dm. The tire comprises axially exterior major grooves of the blind type of a depth of 6.5 mm, on the two axially exterior portions of the tread of the tire having an axial width equal to 0.21 times the axial width of the tread, distributed at a circumferential spacing of 30 mm. The radial distance D1 between the bottom face of the axially exterior major grooves and the crown reinforcement is at least equal to 2 mm.

Various tires were calculated, varying the angle C of the mean linear profile of the axially exterior major grooves with respect to the circumferential direction from 60° to 120°, in steps of 15°. The widths of the axially exterior major grooves are at least equal to 2 mm, which means that the volume void ratio of the tire tread remains the same whatever the angle of the mean linear profile of the axially exterior major grooves. The conditions used for the calculation reproduce the running conditions of a front tire on the outside of the bend, namely the tire that is most heavily loaded in a passenger vehicle. These loadings, for a lateral acceleration of 0.7 g, are as follows: a load (Fz) of 749 daN, a lateral load (Fy) of 509 daN and a camber angle of 3.12°. The following table gives the maximum of the bending stress loadings in the monofilaments as a function of the angle C made by the mean linear profile of the axially exterior major grooves with the circumferential direction. These maximum values are standardized to the value determined for the 120° value for the angle C made by the axially exterior major grooves as base 100.

| | Angle C | | | | |
|---|---|---|---|---|---|
| | 60° | 75° | 90° | 105° | 120° |
| Maximum | 92 | 71 | 58 | 75 | 100 |
| bending stress | | | | | |
| (base 100) | | | | | |

The minimum bending stress is achieved for a mean linear profile of the axially exterior major grooves close to the perpendicular to the bisector of the directions of the monofilaments, namely 90°. In the interval [min(A1,A2)+100°, max(A1, A2)+80°], which, in the example studied, equates to [73°, 107°], the maximum bending stress is at least 25% lower than the maximum bending stress calculated for an angle C of a mean profile close to the perpendicular to the direction of the monofilaments of the second layer A2 of the working reinforcement, namely 120°.

The inventors produced two tires A and B of the size 205/55 R16, corresponding to the tires evaluated in the calculation, tire A, characterized by an angle C made by the mean linear profile of the axially exterior major grooves with the circumferential direction equal to 90°, and tire B, characterized by an angle C equal to 120°. These two tires, inflated to a pressure of 2 bar and subjected to a load (Fz) of 749 daN, a lateral load (Fy) of 509 daN and a camber angle of 3.12°, were subjected to a rolling-road running test on an 8.5 m drum. Running was paused regularly for nondestructive measurement so as to check for breakages of the reinforcing elements in the working layers. In line with the calculation, breakages in the working layers of tire B appear after a distance lower than for tire A by a factor of two.

1. A tire for a passenger vehicle, comprising:
a tread adapted to come into contact with the ground via a tread surface and having an axial width LT,
the tread comprising two axially exterior portions each having an axial width at most equal to 0.3 times the axial width LT,
at least one axially exterior portion comprising axially exterior grooves, an axially exterior groove forming a space opening onto the tread surface and being delimited by at least two main lateral faces connected by a bottom face,
at least one axially exterior groove, referred to as major groove, having a width W, defined by the distance between the two lateral faces, at least equal to 1 mm, a depth D, defined by the maximum radial distance between the tread surface and the bottom face, at least equal to 5 mm, and a mean linear profile L,
the tire further comprising a crown reinforcement radially on the inside of the tread,
the crown reinforcement comprising a working reinforcement and a hoop reinforcement,
the working reinforcement comprising at least two working layers each comprising reinforcing elements which are coated in an elastomeric material, mutually parallel and respectively form, with a circumferential direction of the tire, an oriented angle at least equal to 20° and at most equal to 50°, in terms of absolute value, and of opposite sign from one layer to the next,
said reinforcing elements in each working layer being comprised of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction of the tire, an angle B at most equal to 10°, in terms of absolute value,
wherein the mean linear profile L of any axially exterior major groove of at least one axially exterior portion of the tread forms, with the circumferential direction of the tire, an angle C belonging to the interval [min(A1,A2)+100°, max(A1, A2)+80°],
and wherein the breaking strength R_{C} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

2. The tire according to claim 1, wherein the angle C of the mean linear profile L of any axially exterior major groove of at least one axially exterior portion of the tread belongs to the interval [min(A1,A2)+105°, max(A1, A2)+75°].

3. The tire according to claim 1, wherein the angle C of the mean linear profile L of any axially exterior major groove of at least one axially exterior portion of the tread belongs to the interval [(A1+A2)/2+80°, (A1+A2)/2+100°].

4. The tire according to claim 1, wherein any axially exterior major groove has a width W at most equal to 10 mm.

5. The tire according to claim 1, wherein any axially exterior major groove has a depth D at most equal to 8 mm.

6. The tire according to claim 1, wherein the axially exterior major grooves are spaced apart, in the circumferential direction of the tire, by a circumferential spacing P at least equal to 8 mm.

7. The tire according to claim 1, wherein the axially exterior major grooves are spaced apart, in the circumferential direction of the tire, by a circumferential spacing P at most equal to 50 mm.

8. The tire according to claim 1, wherein the bottom face of an axially exterior major groove is positioned radially on the outside of the crown reinforcement at a radial distance D1 at least equal to 1.5 mm.

9. The tire according to claim 1, wherein the bottom face of an axially exterior major groove is positioned radially on the outside of the crown reinforcement at a radial distance D1 at most equal to 3.5 mm.

10. The tire according to claim 1, wherein at least an axially exterior portion, comprising axially exterior major grooves, comprises sipes having a width W1 at most equal to 1 mm.

11. The tire according to claim 1, wherein the two axially exterior portions each have an axial width at most equal to 0.2 times the axial width LT of the tread.

12. The tire according to claim 1, wherein the angles of the respective reinforcing elements of the working layers are equal in terms of absolute value.

13. The tire according to claim 1, wherein each working layer comprises reinforcing elements which form, with the circumferential direction of the tire, an angle at least equal to 22° and at most equal to 35°.

14. The tire according to claim 1, wherein each working layer comprises reinforcing elements made up of individual metal threads or monofilaments having a diameter at least equal to 0.3 mm and at most equal to 0.37 mm.

15. The tire according to claim 1, wherein the reinforcing elements of the working layers are made of steel.

16. The tire according to claim 1, wherein the density of reinforcing elements in each working layer is at least equal to 120 threads per dm and at most equal to 180 threads per dm.

17. The tire according to claim 1, wherein the reinforcing elements of the at least one hooping layer are made of textile, aromatic polyamide or combination of aliphatic polyamide and of aromatic polyamide, polyethylene terephthalate or rayon type.

18. The tire according to claim 1, wherein the hoop reinforcement is radially on the outside of the working reinforcement.

19. The tire according to claim 15, wherein the steel is carbon steel.

20. The tire according to claim 17, wherein the textile is of aliphatic polyamide.
